(19) United States
(12) Patent Application Publication
(10) Pub. No.: US 2007/0194071 A1
(43) Pub. Date: Aug. 23, 2007

(54) Configurable vehicle storage system and method of use

(76) Inventor: Jerry Jay Hollinger, Lebanon, TN (US)

Correspondence Address: Raymond M. Galasso;Galasso & Associates LP, P.O. Box 26503, Austin, TX, 78755-0503, US

(21) Appl. No.: 11/359,037

(22) Filed: Feb. 21, 2006

(51) Int. Cl. B60R 9/00; B60R 7/00; B60R 11/00

(52) U.S. Cl. 224/542; 224/403

(57) ABSTRACT

A configurable vehicle storage system and method of use are disclosed. In one form, a configurable vehicle storage system includes an expandable horizontal cross member operable to be expanded along a width of a storage compartment of a vehicle. The vehicles storage system further includes a positionable divider having a coupling mechanism operable to be coupled to a receiver of the expandable horizontal cross member at a position along the horizontal cross member to partially define a cavity for storing articles.

### FIELD OF THE DISCLOSURE

The present invention generally relates to storage systems, and more particularly, to a configurable vehicle storage system and method of use.

### BACKGROUND

Conventional motor vehicles include various storage compartments for securing articles. For example, some conventional truck vehicles may be configured with various truck accessories for securely fastening articles within the bed of a truck. One example of a storage compartment includes an external tool box or storage container that may be placed within a truck bed along a width of the truck bed. Such external tool boxes may include a variety of sub compartments for storing tools and other articles to securely store such articles during travel.

Several other conventional solutions for securing articles within a truck bed also exist. For example, a truck cover may be custom fit to the bed of a truck and be snapped along a perimeter of a truck bed. Such covers ensure that contents stored within the bed of a truck are not be blown or accidentally removed from a bed of a truck due to excess wind when traveling. Another form of a conventional rigid covers include hydraulic lift systems to lift the rigid cover to enable access to contents stored within. In another form, a conventional hard-shelled bed cover may be employed to cover the bed of a truck while providing additional height for storing articles. Such hard-shelled covers allow for easy storage and access to articles while reducing wind turbulence that may cause articles to become dislodged and lost during travel. However, most conventional hard-shell covers do not allow for securely coupling articles within a truck bed. Moreover, such hard-shell covers are cost prohibitive to most vehicle owners. As such, what is needed is an inexpensive system for securely storing articles within a bed of a truck while allowing for simplified access.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a configurable vehicle storage system according to one aspect of the present invention;

FIG. 2 illustrates a top perspective view of a vehicle storage system according to one aspect of the invention; and

FIG. 3 illustrates a vehicle storage system employed within a truck bed of a vehicle according to one aspect of the invention.

### DETAILED DESCRIPTION

A configurable vehicle storage system and method of use are disclosed. According to one aspect, a configurable vehicle storage system includes an expandable horizontal cross member operable to be expanded along a width of a storage compartment of a vehicle. The vehicles storage system further includes a positionable divider having a coupling mechanism operable to be coupled to a receiver of the expandable horizontal cross member at a position along the horizontal cross member to partially define a cavity for storing articles.

According to another aspect of the invention, a configurable vehicle storage system includes an expandable horizontal cross member operable to be variably expanded along a width of a storage compartment of a vehicle. The system further includes a series of positionable dividers coupled along the expandable horizontal cross member and partially defining a matrix of individual cavities for storing articles.

According to a further aspect of the invention, a motor vehicle including a storage area for transporting articles is provided. The motor vehicle includes a storage compartment operable to store articles during transport and a configurable storage and organization system. The configurable storage and organization system include an expandable horizontal cross member operable to be expanded along a width of a storage compartment of a vehicle and a positionable divider having a coupling mechanism operable to be coupled to a receiver of the expandable horizontal cross member at a position along the horizontal cross member to partially define a cavity for storing articles.

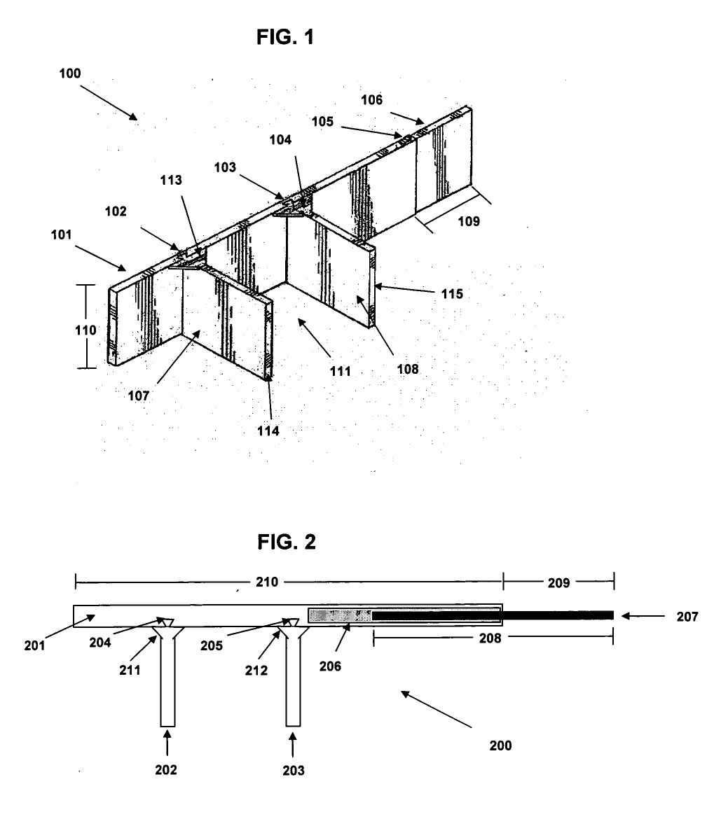

FIG. 1 illustrates a configurable vehicle storage system according to one aspect of the present invention. A configurable vehicle storage system, illustrated generally at 100 includes an expandable horizontal cross member 101 and a first divider 107 and second divider 108 coupled to expandable horizontal cross member 101 using a first coupling mechanism 102 and second coupling mechanism 103 and defining at least a portion of a cavity 111 for storing articles. First coupling mechanism 102 includes a first horizontal coupling mechanism 113 and second coupling mechanism 103 includes a second horizontal coupling mechanism 104 for reducing side-to-side movement of first divider 107 and second divider 108 when coupled to expandable horizontal cross member 101. A ‘dove tail’ or ‘tongue and groove’ coupler is illustrated for coupling first divider 107 and second divider 108 although other coupling mechanisms that allow for altering configurations for configurable vehicle storage system 100 while securing first divider 107 and second divider 108 may be employed.

In one embodiment, expandable horizontal cross member 101 includes an expandable substrate portion 106 operable to be expanded to a width 109. For example, configurable vehicle storage system 100 may be employed within a bed of a truck and as such may be expanded to interface a wall of truck bed (not expressly shown). A locking mechanism 105 may be used to fix width 109 as needed and may include various types of locking mechanisms including but not limited to bolts, spring loaded pegs or pins, a ratchet systems, or any other type of locking mechanism operable to fix expandable substrate portion 106 to width 109. In one embodiment, expandable substrate portion 106 may be spring loaded (not expressly shown). For example, a user may compress expandable substrate portion 106 along a width of a truck bed and coupling expandable substrate portion 106 until expandable substrate portion touches a wall of a truck bed. In this manner, expandable substrate portion 106 may interface a wall of a truck bed to securely couple configurable vehicle storage system 100 to a truck bed. Configureable vehicle stroage system 100 may also be used with other types of vehicles such as vans, cars, cargo trucks, etc.

During use, a user may install configurable vehicle storage system 100 within a truck bed and position configurable vehicle storage system 100 along a rear portion of a truck bed such that first end portion 114 of first divider 107 and second end portion 115 of second divider 108 are proximally located near a tail gate when a tail gate is in an upright position (not expressly shown). Expandable horizontal substrate portion 106 may be extended along a width 109 such that expandable horizontal cross member 101 is proximally or closely located to each side wall of a truck bed (not expressly shown). In one form, configurable vehicle storage system 100 may be provided having a fixed width for a specific truck type and expandable horizontal substrate portion 106 may not be needed.

Upon installing expandable horizontal cross member 101, first divider 107 may be coupled to expandable horizontal cross member 101 by aligning first coupling mechanism 102 and sliding first coupling mechanism 102 within a groove provided within expandable horizontal cross member 101. Similarly, second divider 108 may be coupled to expandable horizontal cross member 101 by aligning second coupling mechanism 103 and sliding first coupling mechanism 103 within a groove provided within expandable horizontal cross member 101. Additional dividers may be used as desired. Upon securing each divider, a cavity 111 is partially defined by first divider 107, expandable horizontal cross member 101, and second divider 108 and a user may place an article within cavity 111 for safe storage and transport. For example, first divider 107, second divider 108 and expandable horizontal substrate 101 may be provided having substantially similar height 110 sufficient to allow for storing of large articles such as paint buckets, propane tanks, or other various articles that may benefit from storage. Various heights from one (1) to two (2) feet may be employed. Addtionally, first divider 101, second divider 102, horizontal cross member XXX and/or expandable horizontal substrate XXX may include a thickness of approximately one half (½) inch to two (2) inches. Cavity 111 may include a depth of approximately twelve (12) inches although other dimensions may be used.

A user may lift an article such as a paint bucket or propane tank onto a tail gate of a truck and place the article within cavity 111. A user may then close the tail gate to provide a fourth wall for cavity 111 and securely surround an article. When a user gets to a destination, a user need only lower the tail gate to access the article stored within cavity 111 obviating the need for a user to have to lift an article over a wall of a truck to remove the article.

FIG. 2 illustrates a top perspective view of a vehicle storage system according to one aspect of the invention. A configurable vehicle storage system, illustrated generally at 200, includes a horizontal cross member 201 having a horizontal cross member width 210 and a cavity 206 for storing expandable horizontal substrate portion 207 having an expandable horizontal substrate width 208. For example, cavity 206 may be configured to store all or a portion of expandable horizontal substrate portion 207 and may include various locking mechanisms and/or spring mechanisms for securely extending and contracting expandable horizontal substrate portion 207 along a desired length 209. Various overall widths (e.g. between four (4) and six (6) feet, etc.) may be employed as needed. Configurable vehicle storage system 200 further includes a first removable divider 202 coupled to horizontal cross member 201 using first coupling mechanism 204 and a second removable divider 203 coupled to horizontal member 201 using second coupling mechanism 205. First divider 202 and second divider 203 include a ‘dove-tail’ or ‘tongue in grove’ coupling mechanism although other coupling mechanisms may be employed. Additionally, first divider 202 and second divider 203 include a first horizontal support element 211 and a second horizontal support element 212 operable to interface horizontal cross member 201 to reduce side-to-side movement of first divider 202 and second divider 203 during use. Configurable vehicle storage system 200 may also be provided in various colors to match a portion of a color of a vehicle and may also be formed from various types and/or combinations of materials such as plastic, rubber, aluminum, stainless steel, alloys, or various other types of materials.

In one embodiment, configurable vehicle storage system 200 may be provided as a collapsible storage system allowing for ease of storage when not being used. For example, first divider 202 and second divider 203 may include hinges or brackets (not expressly show) that allow for folding first divider 202 and second divider 203 along horizontal substrate width 210. As user desires to use configurable vehicle storage system 200, a user need only rotate or flip first divider 202 and second divider 203 such that each divider is perpendicular to horizontal cross member 201. Locking hinges (not expressly shown) may be provided to fix each divider in place during use.

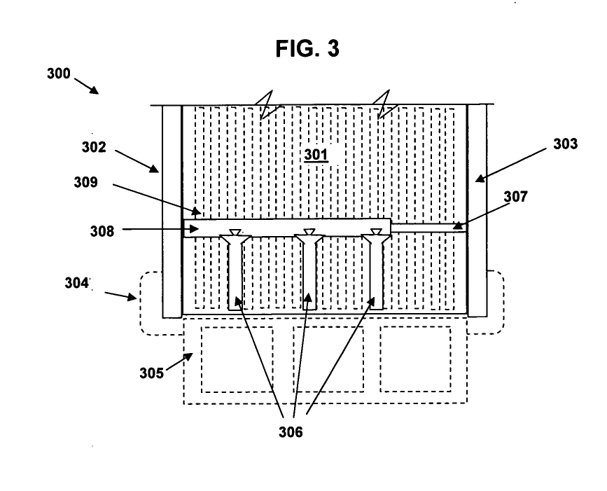

FIG. 3 illustrates a vehicle storage system employed within a truck bed of a vehicle according to one aspect of the invention. A truck bed of a motor vehicle, illustrated generally at 300, includes a left side wall 302, a right side wall 303 and a bed portion 301 there between. Truck bed 300 is coupled to a frame (not expressly shown) and a tailgate 305 is provided to enclose truck bed 300 and may be rotated up and down when loading and unloading articles or cargo. A bumper 304 is also provided as a part of motor vehicle.

Truck bed 300 includes a configurable vehicle storage system 309 located along a rear portion of truck bed 300 for storing articles. Configurable vehicle storage system 309 includes a horizontal cross member 308 coupled to a an expandable cross member 307 operable to expand across a width of truck bed 300. Configurable vehicle storage system 309 further includes a series of dividers 306 arranged to form a matrix of storage regions for securing articles or cargo during travel. Articles may be placed along side of dividers 306 and horizontal cross member 308 and expandable cross member 307. Tailgate 305 may raised to a closed or upward position providing a fourth wall for securing articles stored within each cavity. In this manner, plural cavities for securely storing articles or cargo, such as propane tanks, paint buckets, gasoline, tools, etc. during transit. In one embodiment, dividers 306 and horizontal cross member 308 and/or expandable cross member 307 may be provided with a padded material as needed for reducing damage that may be caused during travel.

Note that although an embodiment of the invention has been shown and described in detail herein, along with certain variants thereof, many other varied embodiments that incorporate the teachings of the invention may be easily constructed by those skilled in the art. Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. Accordingly, the invention is not intended to be limited to the specific form set forth herein, but on the contrary, it is intended to cover such alternatives, modifications, and equivalents, as can be reasonably included within the spirit and scope of the invention.

What is claimed is:

1. A configurable vehicle storage system comprising:
an expandable horizontal cross member operable to be extend along a width of a storage compartment of a motor vehicle; and
a positionable divider having a coupling mechanism operable to be coupled to a receiver of the expandable horizontal cross member at a position along the horizontal cross member to partially define a cavity for storing articles.

2. The system of claim 1 further comprising plural positionable dividers coupled to plural receivers along the expandable horizontal cross member to partially define plural cavities.

3. The system of claim 1 wherein the expandable horizontal cross member includes:
a first stationary substrate having a first height; and
a second movable substrate coupled to a portion of the first stationary substrate and having a second height approximately equal to the first height, the second movable substrate operable to be displaced along a length of the first stationary substrate.

4. The system of claim 3 wherein the first stationary substrate includes a cavity sized to house a portion of the second movable substrate.

5. The system of claim 1, wherein the further coupling mechanism and the receiver comprise a tongue and groove coupling interface.

6. The system of claim 1 further comprising the expandable horizontal cross member operable to be coupled to a wall portion of a bed of a truck.

7. The system of claim 1 wherein the expandable horizontal cross member and the positionable divider comprise approximately the same height.

8. The system of claim 1 wherein the expandable horizontal cross member and the positionable divider comprise different heights.

9. The system of claim 1 wherein the positionable divider includes a horizontal support member coupled along at least one side of the positionable divider.

10. A configurable vehicle storage system comprising:
an expandable horizontal cross member operable to be variably expanded along a width of a storage compartment of a vehicle; and
a series of positionable dividers coupled along the expandable horizontal cross member and partially defining a matrix of individual cavities for storing articles.

11. The system of claim 10 further comprising expandable cross member includes at least two cross members including a first substrate coupled to a second substrate.

12. The system of claim 11 wherein the expandable horizontal cross member includes a collapsed width of approximately four (4) feet and expanded width of approximately six (6) feet.

13. The system of claim 12 wherein the dividers include a length of approximately three (3) feet.

14. The system of claim 11 further comprising the expandable horizontal cross member including a locking mechanism operable to fix the expandable horizontal cross member to the width.

15. The system of claim 14 further comprising the expandable horizontal cross member and positionable dividers operable to be disassembled for storage.

16. The system of claim 15 wherein the expandable horizontal cross member and the dividers comprise a plastic material.

17. A motor vehicle having a storage area for transporting articles comprising:
a vehicle storage compartment operable to store articles during transport; and
a configurable storage and organization system including:
an expandable horizontal cross member operable to be expanded along a width of a storage compartment of a vehicle; and
a positionable divider having a coupling mechanism operable to be coupled to a receiver of the expandable horizontal cross member at a position along the horizontal cross member to partially define a cavity for storing articles.

18. The apparatus of claim 17 a series of positionable dividers coupled along the expandable horizontal cross member and partially defining a matrix of individual cavities including three (3) sides formed from the expandable cross member and the positionable dividers, the expandable horizontal cross member positioned along a length of a tuck bed of the motor vehicle at a distance from a tail gate of the motor vehicle, the tail gate providing a fourth side for each of the individual cavities.

19. The apparatus of claim 17 further comprising:
coupling means for engaging the expandable horizontal cross member to the positionable divider;
expanding means for extending the expandable horizontal cross member along the width of the storage compartment; and
releasing means for removing the positionable divider from the expandable horizontal cross member.

20. The apparatus of claim 17 further comprising a horizontal support member coupled to the positionable divider and operable to reduce side-to-side movement of the positionable divider.
